(19) United States
(12) Patent Application Publication
(10) Pub. No.: US 2014/0334589 A1
(43) Pub. Date: Nov. 13, 2014

(54) APPARATUS FOR HANDLING FUEL ELEMENTS

(71) Applicants: Christian JURIANZ, Krefeld (DE); Stefan BAUER, Einhausen (DE); Stefan Oliver STECK, Ober-Ramstadt (DE)

(72) Inventors: Christian JURIANZ, Krefeld (DE); Stefan BAUER, Einhausen (DE); Stefan Oliver STECK, Ober-Ramstadt (DE)

(21) Appl. No.: 14/271,618

(22) Filed: May 7, 2014

(30) Foreign Application Priority Data
May 8, 2013 (DE) 102013104763.7

(51) Int. Cl. G21C 19/10

(52) U.S. Cl. CPC G21C 19/10
USPC 376/267

(57) ABSTRACT

A system for transfer of fuel elements between an upper pool and a lower pool of a nuclear plant has a conveyor tube having an upper end in the upper pool and a lower end in the lower pool, formed below the upper end with a laterally open port, and extending between the ends at an acute angle to the vertical. A transport basket into which the fuel elements can be placed can be moved through the conveyor tube by a cable hoist having a cable winch outside the tube and a traction cable guided through the conveyor tube and out of the port and extending along and inside the tube. An upper blocking element can close the upper end of the conveyor tube. The cable port is preferably formed by a lateral hole in the conveyor tube preferably provided directly below the upper blocking element.

### FIELD OF THE INVENTION

The invention relates to a system for transfer of fuel elements between an upper pool and a lower pool of a nuclear plant.

### BACKGROUND OF THE INVENTION

A typical nuclear plant has an upper pool in a reactor building and a lower pool of a fuel-element storage unit. The reactor can be a boiling-water reactor, for example, or also a pressurized-water reactor. A transfer stem is typically provided, comprising
a conveyor tube connecting the upper and the lower pool and extending at an acute angle to the vertical,
one or more transport baskets into each of which at least one of the fuel elements can be placed for transport through the conveyor tube,
a cable hoist having a cable winch and a traction cable guided inside the conveyor tube for raising and lowering the transport baskets through the conveyor tube, and
an upper blocking element for closing off the conveyor tube at its upper end.

Replacement and transfer of fuel elements in the plant has particular importance in practice. In this connection, fuel elements generally consist of a bundle of individual fuel rods, and the fuel element itself is equipped with a handle or the like so that it can be transported using suitable machines, for example in order to set it into the reactor vessel or remove it from the reactor vessel. Thus, spent fuel elements, in particular, must be removed from the reactor vessel and transported to a fuel-element storage unit, for example. Conversely, fresh fuel elements must be loaded into the reactor vessel.

In practice, it is usual to fill the upper pool in the reactor building during the fuel element exchange, so that the fuel elements are transported in liquid (water). They are taken out of the open reactor vessel using a handler that can be moved above the reactor vessel and moved into the upper pool and temporarily stored, if necessary, in a buffer pool/cooling pond.

From the upper pool, the fuel elements must be transported to a fuel-element storage unit, for example, using a transfer system, the storage unit also having a (lower) pool, the upper pool (for example in the reactor building) and the lower pool (for example in the fuel-element storage unit) being filled to a different liquid level, independent of one another. Transport using the transfer system takes place between these two pools through a conveyor tube mounted at an angle to the vertical. Such transfer systems are basically known from practice. In this connection, an effort is made to keep the time expenditure for a fuel element exchange as short as possible in order to reduce interruptions in the power operation of the reactor as much as possible. The reduction in the time required for the fuel element exchange has particular importance from an economic point of view.

In a transfer system for fuel elements of a nuclear reactor facility known from U.S. Pat. No. 3,952,885 the fuel elements are transported through a conveyor tube oriented at an angle to the vertical. The conveyor tube leads through the safety sheath that encloses the pressurized reactor vessel of a pressurized-water reactor in a gas-tight manner. The inner pool and the outer pool are filled to the same liquid level during the fuel element exchange, so that no blocking measures in the region of the conveyor tube are necessary during transfer of the fuel elements. Transport takes place using a cable hoist and using a carriage that has two chambers, of which one accommodates a fresh fuel element for the trip there, and the other a spent fuel element for the return trip. In this connection, the carriage can pivot from a vertical transfer position into a horizontal or angled transport position. The known transfer system exclusively serves for transfer of fuel elements between two pools filled to the same liquid level.

The same holds true for the transfer system known from U.S. Pat. No. 4,096,031, with which fuel elements are transported directly between the reactor vessel and a storage container mounted directly next to it, where the reactor vessel and the storage container are connected with one another by a transport tube that extends at an acute angle to the vertical. Transfer devices are provided at the end of this conveyor tube that can pivot the fuel elements from an angled transport position into a vertical transfer position. Transfer through the conveyor tube takes place using a cable hoist that directly grips the fuel element with a grab.

U.S. Pat. No. 3,058,900 describes a charging apparatus for nuclear reactors in which fuel elements are transported directly between the reactor vessel and a channel that runs horizontally below the reactor vessel, the reactor vessel and the channel being connected with one another by a tube that is oriented at an angle to the vertical. For transport, a fuel element is inserted into a cartridge that can be transported through the tube, the cartridge bing provided at the top with a handle or the like so that it can be gripped by a tool. The tube can be closed off completely using a blocking element. This blocking element is opened when a fuel element exchange takes place by means of the charging apparatus.

A loading and unloading apparatus for fuel elements is known from U.S. Pat. No. 4,202,729 in which the apparatus sits on the top of the reactor vessel and has two ramps extending at an angle to the vertical in opposite directions and between which the fuel elements can pivot using a pivoting apparatus. An apparatus having a similar construction is known from U.S. Pat. No. 4,440,718.

### Objects of the Invention

It is therefore an object of the present invention to provide an improved transfer system.

Another object is the provision of such an improved transfer system that overcomes the above-given disadvantages, in particular that provides fast and efficient transfer of fuel elements between an upper pool and a lower pool of a nuclear plant where the liquid level of the upper pool (even during transport) preferably lies above the liquid level of the lower pool.

### SUMMARY OF THE INVENTION

A system for transfer of fuel elements between an upper pool and a lower pool of a nuclear plant. The system has according to the invention a conveyor tube having an upper end opening into the upper pool and a lower end opening into the lower pool, formed below the upper end with a laterally open port, and extending between the ends at an acute angle to the vertical. A transport basket into which at least one of the fuel elements can be placed can be transported through the conveyor tube by a cable hoist having a cable winch outside the tube and a traction cable guided through the conveyor tube and out of the port and extending along and inside the tube for raising and lowering the transport baskets through the conveyor tube. An upper blocking element can close the upper end of the conveyor tube. The cable port is preferably formed by a lateral hole in the conveyor tube preferably provided directly below the upper blocking element.

In this connection, the invention first of all proceeds from the recognition that perfect transfer of the fuel elements through a conveyor tube is possible using a cable hoist. Such cable hoists are used in the transfer systems described in the above prior-art systems in which the two pools between which transfer takes place are filled to the same liquid level, because in this case, blocking elements can easily be opened during transport. According to the invention, transport now takes place using a cable hoist between an upper pool and a lower pool even if they are filled to a different liquid level during transport. In order to prevent the liquid from flowing out of the upper pool into the lower pool through the conveyor tube, first of all an upper blocking element is provided that can completely close the conveyor tube can be (completely) at the top. This blocking element can also be closed during transport—at least part of the time—because according to the invention, the traction cable of the cable hoist does not enter the conveyor tube from the end, by the cable winch, but rather through an (upper) lateral cable port so that the cable feed into the conveyor tube takes place below the upper (fully closing) blocking element. This has the advantage that the upper blocking element can basically be closed again (immediately) after introduction of the fuel elements into the conveyor tube, because transport is possible using the cable hoist even when the upper blocking element is closed. The upper blocking element consequently only has to be opened for a short period of time if the fuel elements must be lowered or raised past the upper blocking element. Therefore a perfect transfer of the fuel elements between an upper pool and a lower pool takes place even if these pools are at different liquid levels. Passage of liquid from the upper pool into the lower pool can be reduced to a minimum, so that any pump power that might be required for pumping liquid back can be reduced to a minimum.

According to the invention, the fuel elements themselves are passed through the conveyor tube not directly, but rather in transport baskets. Preferably, each transport basket accommodates a plurality of fuel elements, for example four fuel elements, so that accelerated fuel element exchange is possible.

In this connection, it is particularly practical if the cable hoist does not directly engage the transport baskets (at the top), but rather preferably a lift carriage guided inside the conveyor tube is connected with the traction cable so the transport baskets can be set onto this lift carriage. The lift carriage is consequently mounted underneath the transport basket during transport. Such an embodiment allows, among other things, a combination with the cable port below the upper blocking element, because the lift carriage does not have to travel completely out of the conveyor tube at the top, but rather merely as far as into the region of the upper end of the conveyor tube.

Preferably, the conveyor tube is equipped with not just one but rather with a plurality of blocking elements. Thus, at least one (intermediate) blocking element that can be formed as a partially closing blocking element provided with a cable passage through which the traction cable can pass in the closed position is provided below the upper blocking element. By means of these measures, too, transport between an upper pool and a lower pool that are filled to different liquid levels can be accomplished with a cable hoist in a particularly advantageous manner. In order to further reduce or prevent any flow of liquid from the upper pool into the lower pool during transport, at least one such partially closing blocking element is integrated into the conveyor tube. A partially closing blocking element is a blocking element that can be moved between a completely open position on the one hand and a closed position on the other hand and that has a cable passage in the closed position (closing position) and consequently a correspondingly dimensioned opening so that the traction cable of the cable hoist can pass through the blocking element for perfect transfer. The slight leaks that might occur due to the cable passage can be accepted and compensated for again by appropriate pumping. Here, too, the deciding factor is the fact that such leaks can be reduced to a minimum in this way.

Preferably, the conveyor tube is equipped with a plurality of such intermediate elements, for example two intermediate elements. In this manner, these blocking elements can be opened and closed one after the other, in terms of time, essentially like a lock system, so that during lowering of the fuel elements through the conveyor tube, for example, each intermediate blocking element only has to be completely opened for a short time when the fuel elements are passing the blocking element.

Furthermore, a (fully closing) blocking element is preferably provided at the lower end of the conveyor tube, so that the intermediate blocking elements are preferably provided between the upper blocking element and the lower blocking element.

The blocking elements can be configured in the most varied manner, in terms of design. Thus, it is practical to configure the upper and/or lower blocking elements, for example the fully closing blocking elements, as slides, for example as pneumatically, electrically or hydraulically driven slides. Alternatively, however, the upper/lower and/or fully closing blocking elements can also be configured as ball valves, for example pneumatically, electrically or hydraulically driven ball valves.

The partially closing blocking elements are preferably configured as ball valves whose balls are provided with a cable passage (for example a groove). However, the possibility also exists, alternatively, of configuring the partially closing blocking elements as slides, and of providing their slide plates with a cable passage. In the case of the partially closing blocking elements, too, a pneumatic actuator is preferably provided. Alternatively, electrical or hydraulic drives can also be used.

The transfer system according to the invention is preferably equipped with an upper transfer device in the upper pool for loading fuel elements into and unloading them from the transport baskets and with a lower transfer device in the lower pool for loading fuel elements into and unloading them from the transport baskets. In this connection, two transport baskets can be set into the upper transfer device and/or the lower transfer device, are horizontally displaceable for positioning above or below the conveyor tube, and can pivot during displacement (preferably automatically) between a vertical transfer position and an angled transport position. The upper and/or lower transfer device can have two pivot frames into each of which a transport basket can be set and in which the respective transport baskets can pivot between a vertical transfer position and an angled transport position. In this connection, it is practical if the two pivot frames with the transport baskets provided in them are mounted so as to pivot about a common horizontal axis in opposite directions, with the two pivot frames preferably pivotably displaceable horizontally, and pivotal automatically during displacement (by the transport baskets set into them). In this preferred variant, pivoting of the transport baskets in the opposite direction consequently takes place simultaneously during positioning of the transfer device, so that trouble-free and fast transfer is possible. Particularly preferably, (precisely) three transport baskets are used, so that one transport basket is always in the upper transfer device and one transport basket in the lower transfer device, and a third transport basket can then be passed through the conveyor tube. In this manner, simultaneous transfer in the upper transfer device and in the lower transfer device, and also transport through the conveyor tube can take place at the same time. In detail, reference is made to the figure description in this regard.

Furthermore, it is practical that the transport baskets and/or the lift carriage is/are guided on guide rails by guide elements, for example guide rollers, the rails being mounted on the inside wall of the conveyor tube. If the transfer device with pivot frames as described is used, it is furthermore practical if the pivot frames are also equipped with guide rails for at least the transport baskets, and, if applicable, also for the lift carriage.

### BRIEF DESCRIPTION OF THE DRAWING

The above and other objects, features, and advantages will become more readily apparent from the following description, reference being made to the accompanying drawing in which:

FIG. 1 is a perspective vertical section through a nuclear plant with reactor building and fuel-element storage unit,

FIG. 2 is a large-scale detail view of the structure shown in FIG. 1 in the region of the upper transfer device,

FIG. 3 is a large-scale detail view of the structure shown in FIG. 1 in the region of the lower transfer device,

FIG. 4 is a different view of the upper transfer device,

FIG. 5 is a large-scale detail view of the structure shown in FIG. 4,

FIGS. 6a and 6b show the upper transfer device in two different functional positions,

FIGS. 7a and 7b are further large-scale detail views of the structure shown in FIG. 1 in a different view,

FIGS. 8a and 8b are large-scale detail views of the structure shown in FIG. 7a in different functional positions,

FIG. 9 is a different and partly cut-away view of the conveyor tube during transport, and

FIGS. 10a and 10b show the lower transfer device in different functional positions.

### SPECIFIC DESCRIPTION OF THE INVENTION

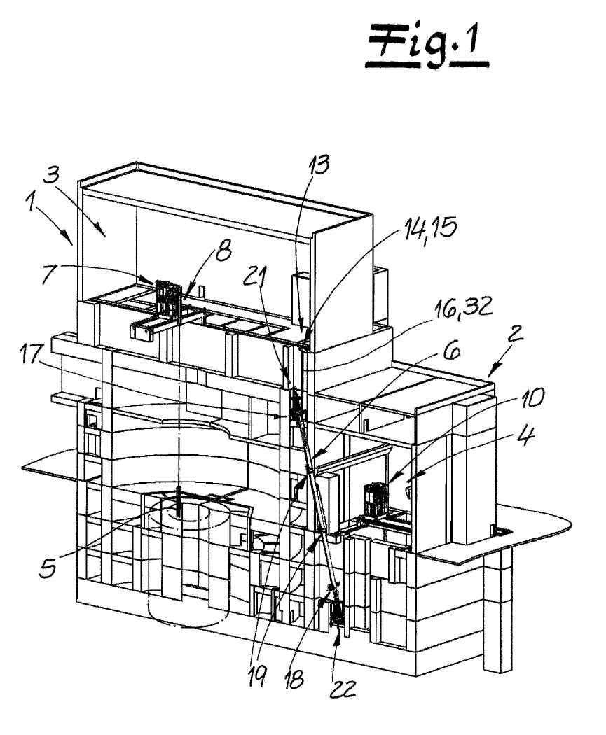

FIG. 1 shows in a simple view a nuclear reactor facility having a reactor building 1 in which an unillustrated nuclear reactor, for example a boiling-water reactor, is provided. A fuel-element storage unit 2 is provided next to the reactor building 1. An upper pool 3 filled to an upper level with liquid lies in the reactor building. A lower pool 4 filled to a lower liquid level is provided near the fuel-element storage unit 2. During a fuel element exchange, (spent) fuel elements 5, for example, are moved by a transfer system 6 out of the reactor, through the upper pool 3, and into the region of the lower pool 4 and/or conversely new fuel elements are transported upward. To remove the fuel elements 5 from the reactor vessel, a handler 7 is provided in the reactor building 1 that can remove a fuel element 5 from the reactor vessel, for example, and transport it to the transfer system 6 in the region of the upper pool 3. To this end, the handler 7 can be equipped with for example a telescoping grab 8 that can grip a handle 9 of the fuel element 5. Similarly, a handler 10 provided in the fuel-element storage unit 2 can move the fuel elements 5 away from or to the transfer system 6. The present invention concerns itself with the transfer system 6 that can transport the fuel elements 5 between the upper pool 3 of the reactor building 1 and the lower pool 4 of the fuel-element storage unit 2, the liquid level of the upper pool lying above the liquid level of the lower pool. The transfer system 6 has a conveyor tube 11 extending at an acute angle to the vertical between the upper and lower pools. Furthermore, the transfer system has a plurality of transport baskets 12, i.e. the fuel elements themselves are transported through the conveyor tube 11 not directly, but rather in the transport baskets 12, and in this embodiment four fuel elements can be set into a transport basket. Furthermore, the transfer system 6 has a cable hoist 13 in turn that has a cable winch 14, a drive 15, and a traction cable 16 and that works in the conveyor tube 11 for raising and lowering the transport baskets 12. The conveyor tube 11 is equipped with a plurality of blocking elements 17, 18, and 19 that can close off the tube passage to prevent or minimize flow of liquid from the upper pool 3 into the lower pool 4. The conveyor tube 11 is provided at its upper end with an upper fully closing blocking element 17, and, at its lower end, with a lower fully closing blocking element 18, these blocking elements 17, 18 being configured as slides. Sufficient space is available at these locations for use of slides. A plurality of further blocking elements, namely a plurality of partially closing intermediate elements 19, are provided between the upper blocking element 17 and the lower blocking element 18; in this embodiment, these are configured as ball valves. Ball valves are used at these locations because the conveyor tube 12 runs inside a concrete sleeve and relatively little space is available.

The difference between the fully closing blocking elements 17 and 18 and the partially closing blocking elements 19 is that the partially closing blocking elements are provided with a cable passage 30 through which the traction cable 16 can pass in the closed position of the blocking element 19. In contrast, the fully closing blocking elements 17 and 18 are configured without such cable passages. The blocking elements 17, 18, and 19 must be opened completely to be able to move a transport basket 12 through the respective locations. The partially closing blocking elements 19 can, however, be closed after the transport basket 12 has passed because the traction cable 16 of the cable hoist passes through the cable passage 30 even in the closed valve position. The transfer system 6 furthermore has a lift carriage 20, i.e. the traction cable 16 of the cable hoist 13 does not engage the transport baskets 12, but rather is connected with the separate lift carriage 20 that engages underneath the transport basket 12, i.e. the transport basket 12 is set onto the lift carriage 20 during transfer. The advantages of this configuration will be discussed below.

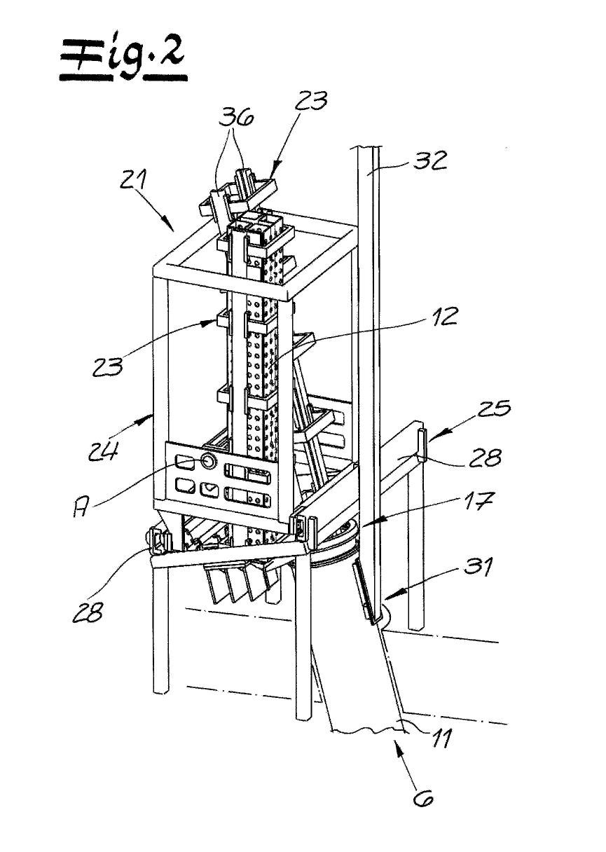

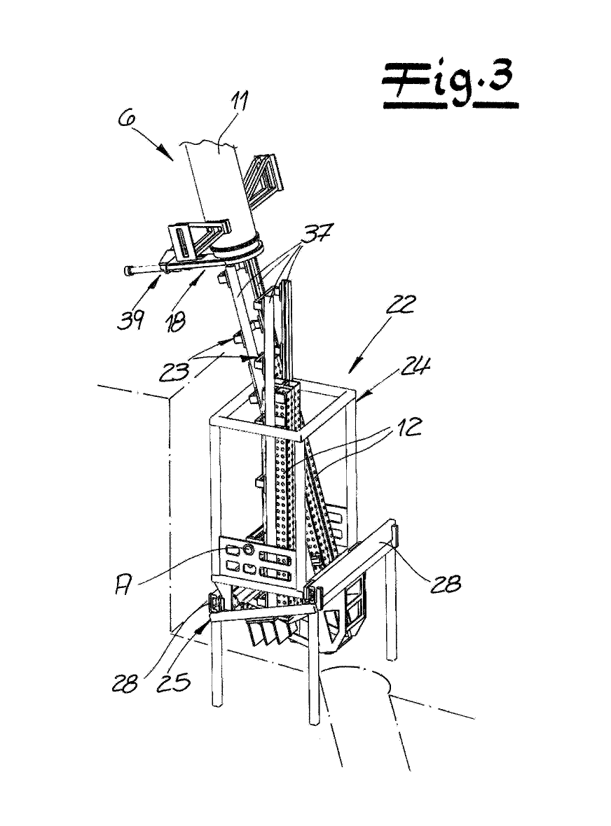

Furthermore, the transfer system 6 according to FIG. 2 has an upper transfer device 21 in the upper pool 3 for loading the fuel elements 5 into and/or unloading them from the baskets 12. In the lower pool 4, the transfer system 6 has a lower transfer device 22 (FIG. 3) for loading the fuel element 5 into and/or unloading them from the baskets 12.

For the transfer of the fuel elements 5 from the upper pool 3 into the lower pool 4, first a transport basket 12 is loaded with fuel elements 5 by the upper transfer device 21. Then, the transport basket 12 is transported by the upper transfer device 21 through the conveyor tube 11 into the region of the lower transfer device 22, specifically using the cable hoist 13. In the lower transfer device 22, the fuel elements 5 can then (for example using the handler 10) be removed from the transport basket 12. Subsequently, the transport basket 12 (for example empty without fuel elements) can be transported back up through the conveyor tube 11, again using the cable hoist 13.

In order to guarantee a rapid and thereby efficient transfer, the upper transfer device 21 and the lower transfer device 22 can each be loaded with two of the baskets 12 that can be displaced horizontally for positioning above or below the conveyor tube 11, and, during displacement can pivot, preferably automatically, between a vertical transfer position and an angled transport position. The transport baskets 12 are consequently loaded with the fuel elements 5 in the vertical transfer position and accordingly the fuel elements 5 are also removed from the transport baskets 12 in this vertical transfer position. For transport through the conveyor tube 11, the transport baskets 12 are then pivoted into the angled transport position. In this embodiment, this pivoting of the transport baskets 12 takes place automatically during displacement of the transport baskets 12. This will be explained first using the upper transfer device 21 as an example. The upper transfer device 21 is equipped with two pivot frames 23 into each of which a transport basket can be set and in which the transport baskets 12 can pivot between a vertical transfer position and an angled transport position. In this connection, the two pivot frames 23, with the transport baskets 12 provided in them, are mounted so as to pivot about a common (horizontal) axis A in opposite directions. The two pivot frames 23 can be jointly displaced horizontally, and can be automatically pivoted by the transport baskets 12 set into them, during displacement, specifically in opposite directions. To this end, the two pivot frames 23 are mounted so as to pivot in a common displacement frame 24 and can be displaced with it, the pivot frames with the transport baskets 12 set into them being positionable relative to the conveyor tube by displacement of the displacement frame 24 in the support frame 25, and, in this connection, being automatically pivotable. This is possible by means of control rails 26 that are curved in this embodiment, the pivot frames 23 or the transport baskets 12 set into them being guided in the control rails 26 during displacement such that the transport baskets 12 pivot automatically because the transport baskets 12 in this embodiment have control pins 27 on the lower side that engage into the control rails 26. In this connection, the support frame 25 has two guide rails 28 in which the displacement frame 24 is guided horizontally and linearly, specifically by a drive 29.

The lower transfer device 22 is configured similarly, and also has a support frame 25, a displacement frame 24, and two pivot frames 23. Preferably, three transport baskets are provided.

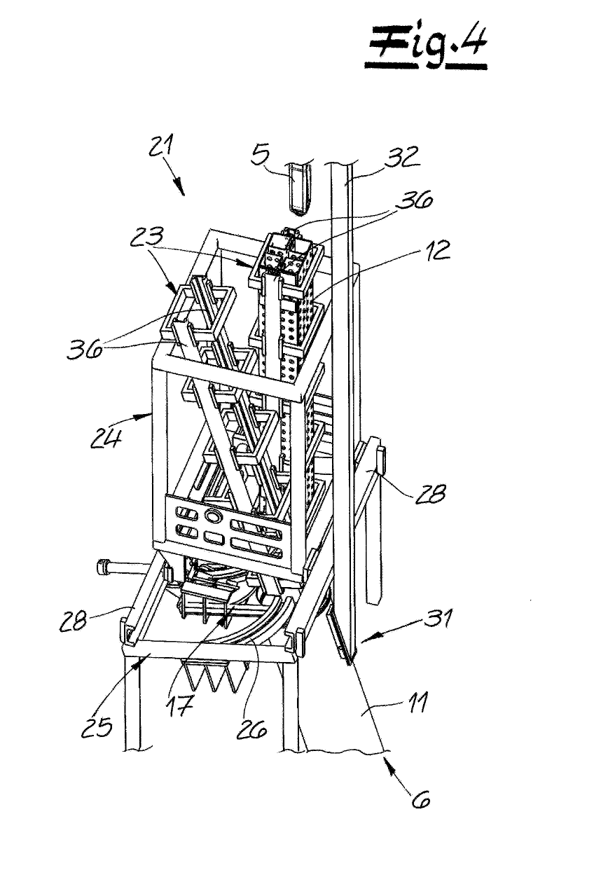

The method of functioning of the transfer system 6 according to the invention will now be explained using FIGS. 4 to 10a and 10b. First, the fuel elements 5 are removed from the reactor vessel using the handler 7 and transported into the region of the upper transfer device 21. There, a transport basket 12 is in a pivot frame 23, in the vertical transfer position, so that four fuel elements can be set into the transport basket 12 (see FIG. 4). This transport basket 12 is situated, in the vertical transfer position laterally offset next to the conveyor tube 11. An empty transport basket 12 is above the conveyor tube 11, for example, in the angled transport position where this empty transport basket 12 was transported upward during loading of the other transport basket from the region of the lower transfer device 22, for example.

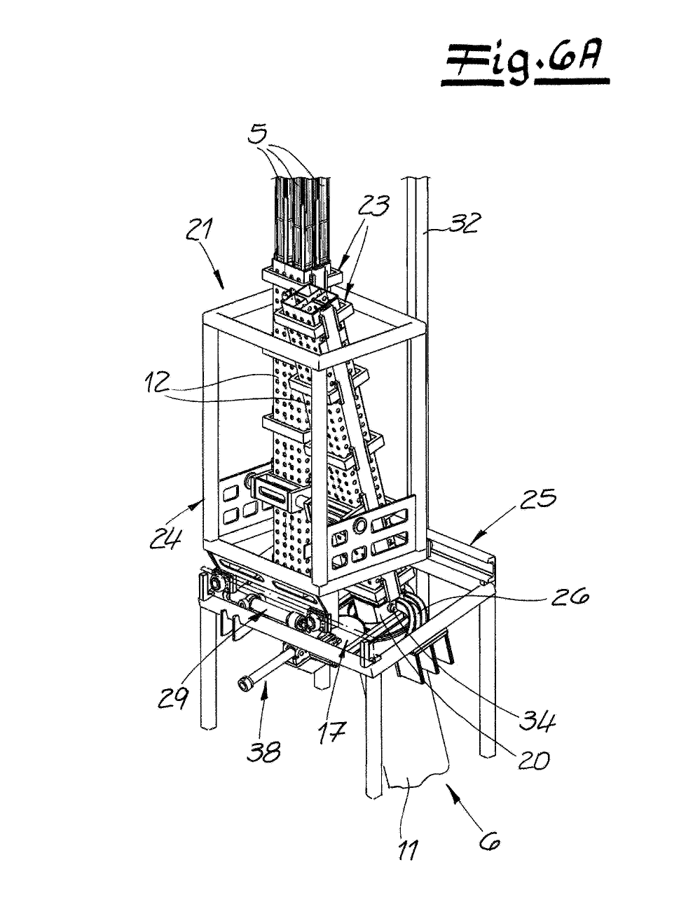

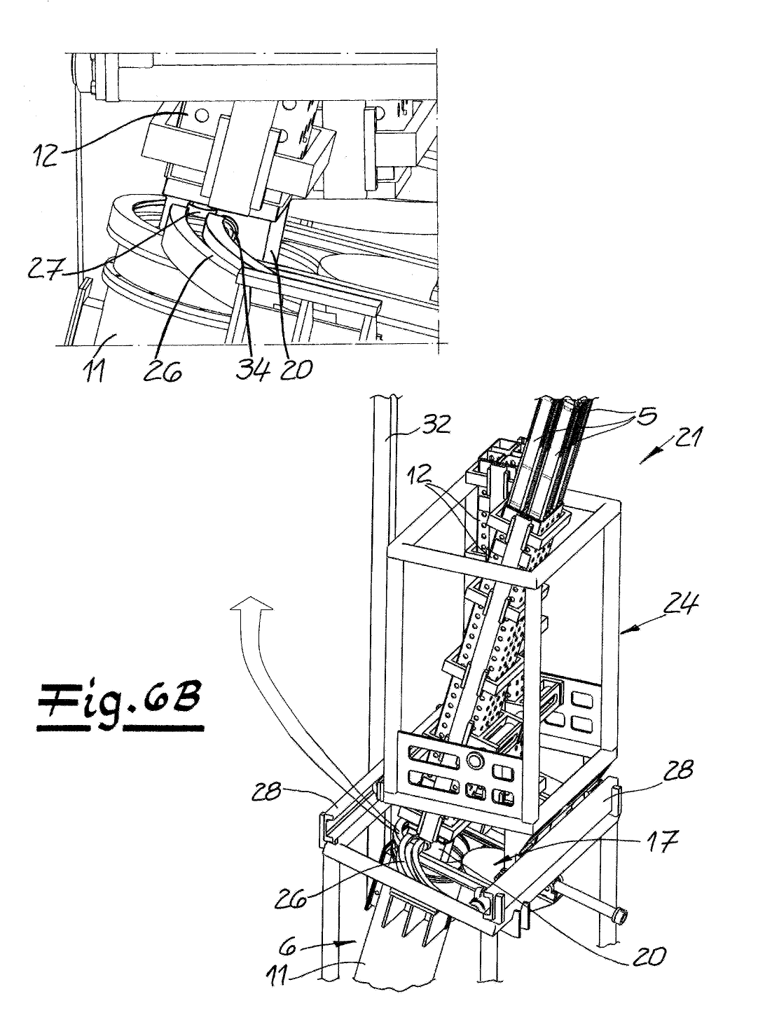

In order to now position the filled transport basket 12 above the conveyor tube 11, the displacement frame 24 with the pivot frames 23 provided in it is displaced. This is evident from a comparison of FIGS. 6a and 6b that show the upper transfer device 21 in different functional positions and in different views. The transport baskets 12 engage into the control rails 26 with their lower control pins 27, so that during displacement of the displacement frame 24, and thereby also of the pivot frames 23, these pivot frames 23 with the transport baskets 12 set into them pivot in opposite directions, so that the filled transport basket 12 is not only positioned above the conveyor tube 11, but also, at the same time, pivoted from the vertical transfer position into the angled transport position.

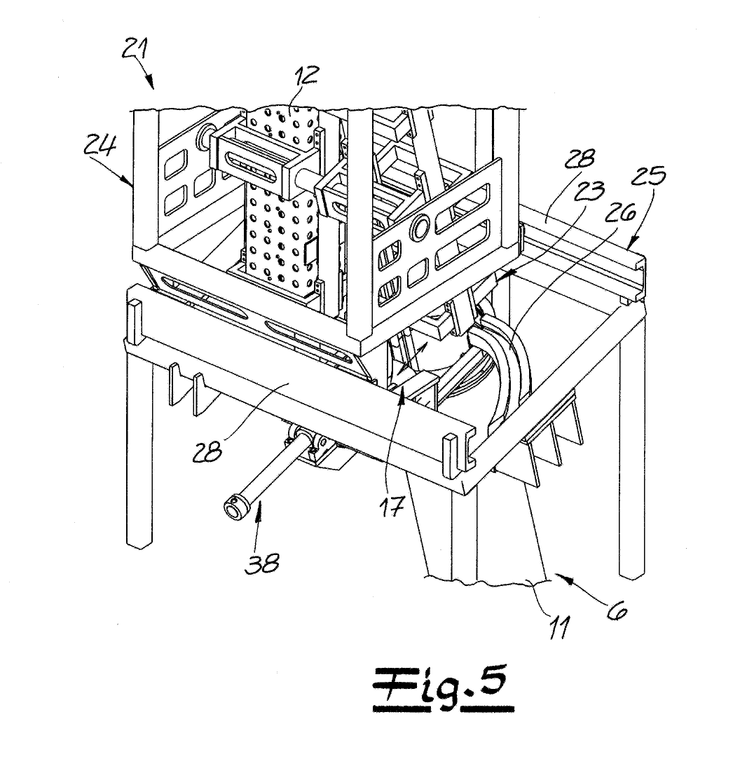

The lift carriage 20, with which an empty transport basket 12 was previously transported from below to above, is consequently still in the region of the upper end of the conveyor tube 11, so that the filled transport basket 12 is set onto the lift carriage 20 during displacement of the displacement frame 24. The upper blocking element 17 is open, in this connection (see FIG. 5).

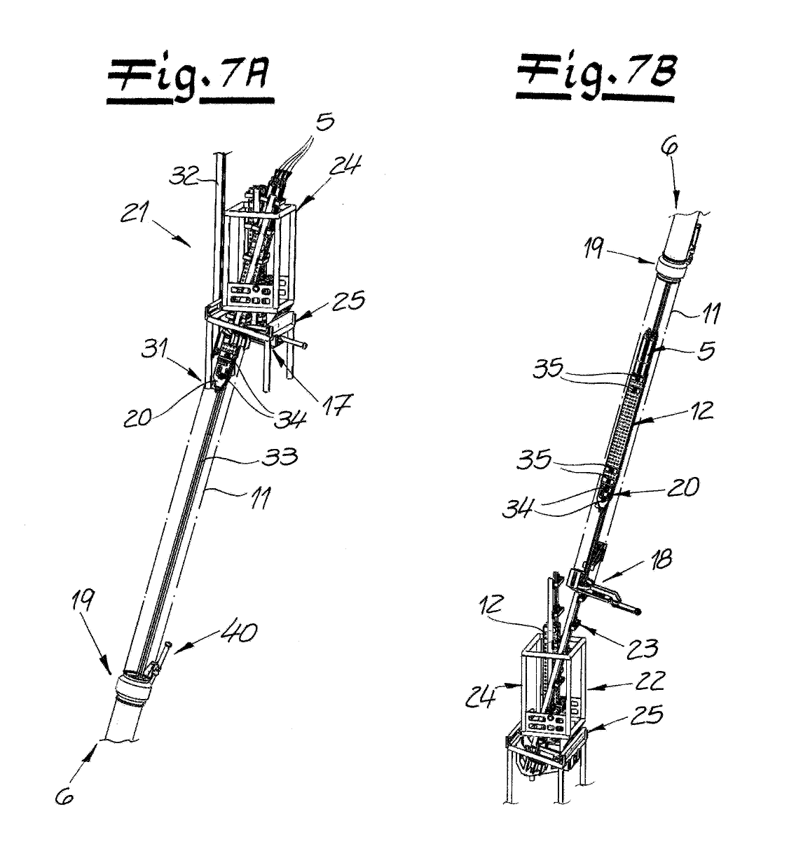

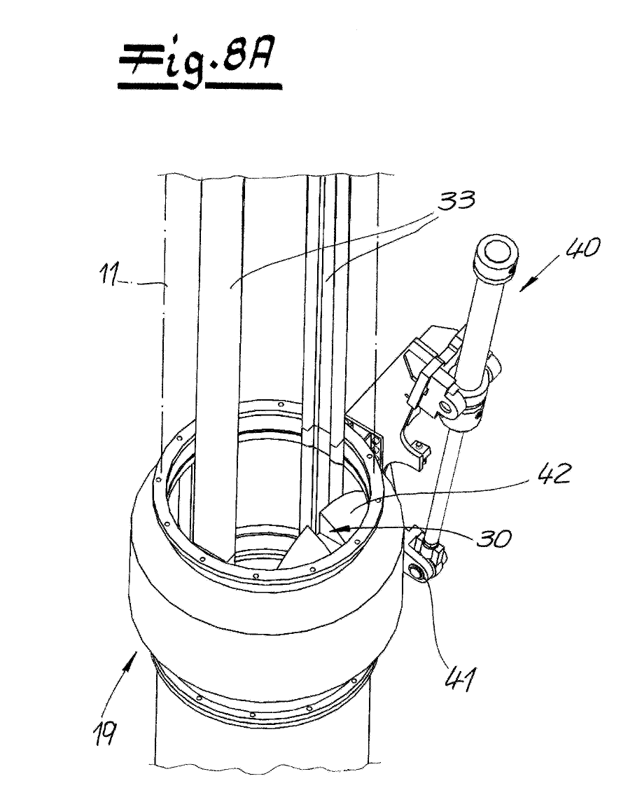

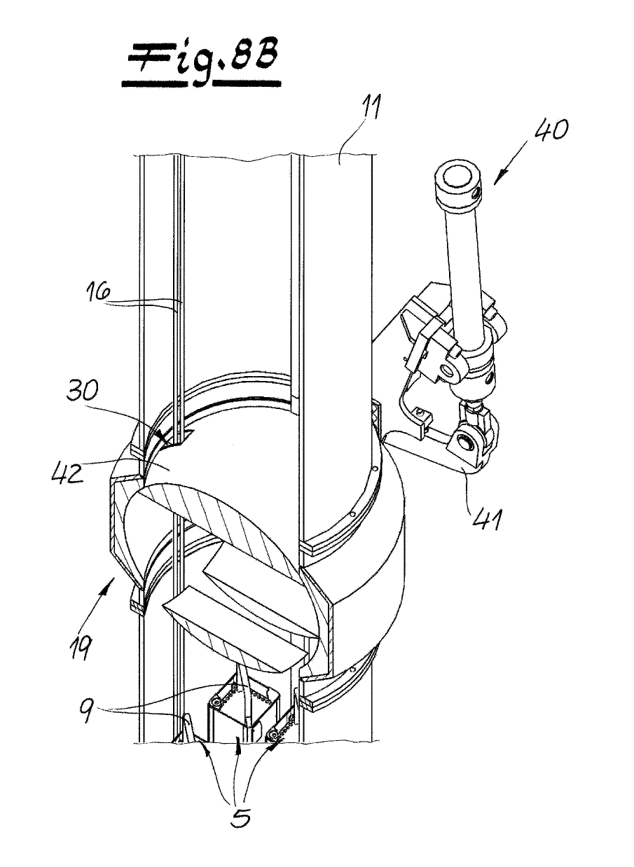

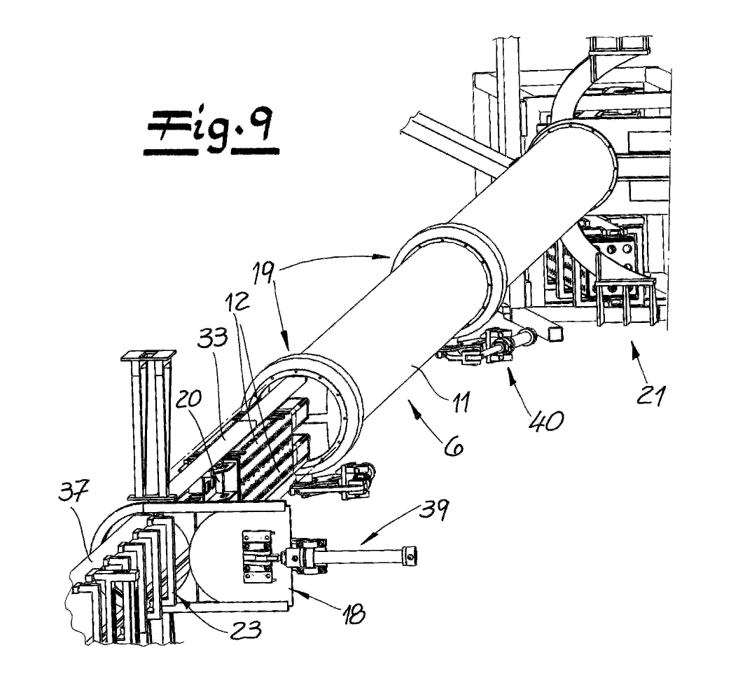

Now the lift carriage 20, with the filled transport basket 12 set onto it, can be lowered using the cable hoist 13 (see FIGS. 7a and 7b). The lower blocking element 18 is closed, at first. The same holds true for the intermediate valves (ball valves 19) inside the conveyor tube 11. During lowering of the lift carriage 20 with the transport basket 12, the intermediate valves 19 are then individually opened step by step, in the manner of a lock system, and, after the lift carriage with transport basket 12 has moved through, are immediately closed again. This is possible because the intermediate valves 19 each have a cable passage 30 through which the traction cable 16 can pass in the closed position of this valve. In this manner, flow of liquid out of the upper pool 3 into the lower pool 4 during transport is prevented (see FIGS. 8a and 8b).

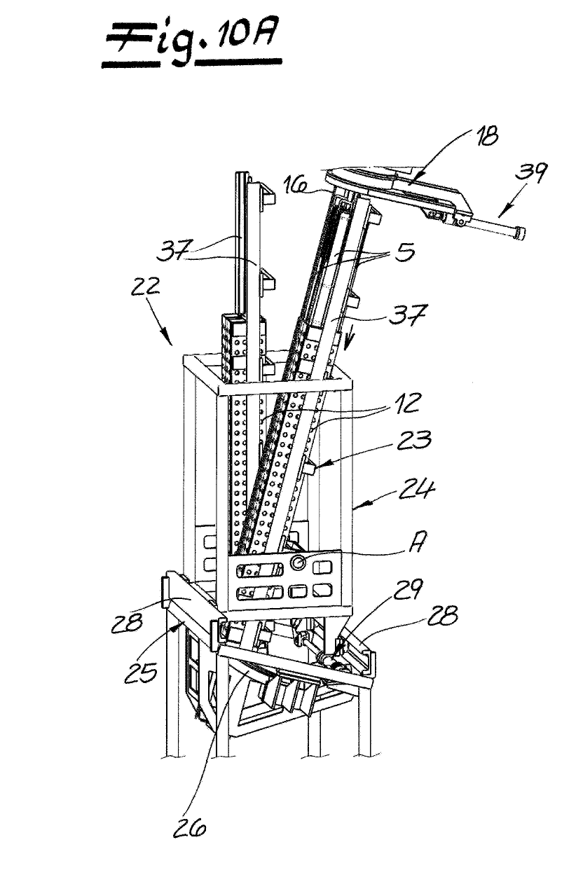

Before the transport basket 12 can exit the conveyor tube 11 at the lower end, the lower slide 18 is opened. In this regard, reference is made to FIG. 9 that shows the conveyor tube 11 in a view at an angle from below. It can be seen that the transport basket 12 is lowered below the lower intermediate valve 19, where this intermediate valve 19 is closed. The lower slide 18 is opened.

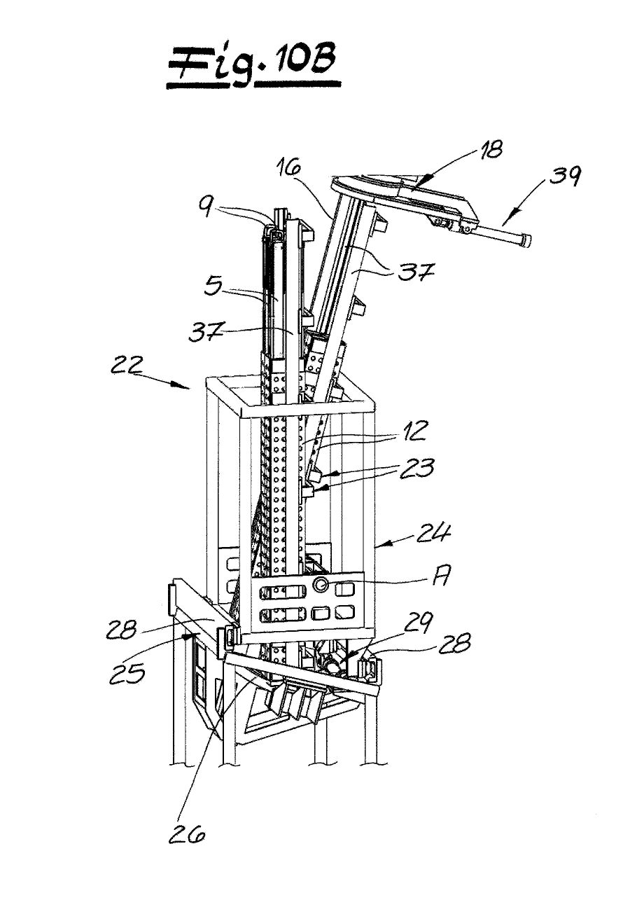

The lift carriage 20 with the transport basket 12 set onto it then exits from the conveyor tube 11 on the lower side, and consequently enters into the lower transfer device 22. In this regard, reference is made to FIGS. 10a and 10b.

Consequently, the filled transport basket 12 is in the angled transport position in the lower transfer device 22, and furthermore, once again an empty transport basket 12 is provided in the vertical transfer position. The displacement frame 24 can be displaced again, so that the transport baskets are positioned and pivoted accordingly. The filled transport basket 12 consequently assumes the vertical transfer position, while the empty transport basket 12 assumes the angled transport position below the conveyor tube 11. Now the empty transport basket 12 can once again be transported upward with the lift carriage 20. During the same time, the filled transport basket 12 can be unloaded by the lower handler 10.

This makes it clear that the fuel elements can be transferred rapidly. In particular, loading can take place in the upper transfer device, and unloading can take place in the lower transfer device, at the same time. In particular, transport of a further transport basket 12 can be done by the transfer system during loading and unloading. Consequently, at least two transport baskets are preferably provided. In this embodiment, however, three transport baskets are provided, one transport basket always being in the upper transfer device and one transport basket in the lower transfer device, while a third transport basket can be transported between the upper transfer device and the lower transfer device.

FIG. 2, further shows that the traction cable 16 of the cable hoist 13 does not enter into the conveyor tube through the upper end of the conveyor tube 11, but rather that the conveyor tube 11 has below the upper slide 17 a lateral cable port 31 through which the traction cable 16 passes out of the tube interior to the cable winch 14, specifically through a cable guide tube 32. This cable port 31 is consequently provided below the slide 17 and, in particular, below the upper transfer device 21. Such a cable port is particularly practical in connection with the lift carriage 20 that, as described, is underneath the transport baskets 12.

The figures furthermore show guide rails 33 inside the conveyor tube 11. The lift carriage 20 is equipped with guide elements, namely rollers 34 that are guided in these rails 33. The transport baskets are also equipped with guide elements 35 in the form of rollers also guided in the guide rails 33. Furthermore, guide rails 36 are also provided in the region of the upper transfer device 21, as are guide rails 37 in the region of the lower transfer device.

The upper transfer device 21 and the lower transfer device 22 are configured to be functionally equivalent in this embodiment. They differ, in terms of design, in specific details. This relates, for example, to the pivot frames 23. The pivot frames 23 of the upper transfer device are laterally closed on all sides, while the pivot frames 23 of the lower transfer device are open on one side. This is connected with the fact that the traction cable 16 in the lower transfer device 22 must be guided past the pivot frames 23, so pivoting of the pivot frames 23 must not be hindered by the traction cable.

Finally, the figures also show that the blocking elements 17, 18, and 19 are operated pneumatically. To this end, the upper slide 17 is provided with a pneumatic actuator 38. The lower slide 18 is also provided with a pneumatic actuator 39. The ball valves 19 are also provided with linearly acting pneumatic actuators 40 that engage the valve ball 42 of the valve 19 via a crank arm 41, this valve ball 42 having the cable passage 30 as described, configured as a hole of the valve ball 42.

In this embodiment, pneumatic actuators are indicated. Alternatively, however, electrical or hydraulic drives can also be used.

We claim:

1. A system for transfer of fuel elements between an upper pool and a lower pool of a nuclear plant, the system comprising:
a conveyor tube having an upper end opening into the upper pool and a lower end opening into the lower pool, formed below the upper end with a laterally open port, and extending between the ends at an acute angle to the vertical;
a transport basket into which at least one of the fuel elements can be placed for transport through the conveyor tube;
a cable hoist having a cable winch outside the tube and a traction cable guided through the conveyor tube and out of the port and extending along and inside the tube for raising and lowering the transport baskets through the conveyor tube; and,
an upper blocking element for closing off the upper end of the conveyor tube.

2. The system defined in claim 1, wherein a liquid level of the upper pool is above a liquid level of the lower pool.

3. The system defined in claim 2, wherein the cable port is formed by a lateral hole in the conveyor tube below the upper blocking element.

4. The system defined in claim 1, further comprising:
a cable guide tube extending laterally from the conveyor tube at the cable port and communicating with the cable port, the cable being guided through the guide tube.

5. The system defined in claim 1, further comprising:
a lift carriage movable internally along the conveyor tube, connected with the traction cable, and adapted to carry a transport basket.

6. The system defined in claim 1, further comprising:
at least one partially closing blocking element formed with a cable passage through which the traction cable can pass in a closed position of this partially closing blocking element and in the conveyor tube below the upper blocking element.

7. The system defined in claim 1, wherein the upper blocking element is fully closing and does not have a cable passage, has at its lower end a lower fully closing blocking element without a cable passage, the system further having
a partially closing intermediate blocking element between the upper and the lower blocking elements and formed with a cable passage.

8. The system defined in claim 1, further comprising:
respective upper and lower transfer devices in the upper and lower pool for loading the fuel elements into and unloading them from the transport basket, each of the transfer devices being capable of holding two of the transport baskets, and the transport baskets are pivotal when in the transfer devices between a vertical transfer position and an angled transport position.

9. The system defined in claim 8, wherein each of the upper and lower transfer devices has two pivot frames into each which a respective transport basket can be set and in which the transport baskets can pivot between the vertical transfer position and the angled transport position, the pivot frames with the transport basket in them being mounted so as to pivot about a common axis in opposite directions.

10. The system defined in claim 9, wherein the two pivot frames of each device can be jointly displaced horizontally and automatically pivoted during displacement by the transport baskets set into them, the system further comprising:
control rails carrying the pivot frames and the respective transport baskets set into them during displacement in such a manner that the transport baskets pivot automatically, the baskets having control pins guided in the control rails.
